(19) United States
(12) Patent Application Publication
(10) Pub. No.: US 2021/0339549 A1
(43) Pub. Date: Nov. 4, 2021

(54) Loose-leaf binder and process of producing same

(71) Applicant: ZeYan Ying, Shenzhen (CN)

(72) Inventor: ZeYan Ying, Shenzhen (CN)

(21) Appl. No.: 17/375,018

(22) Filed: Jul. 14, 2021

(30) Foreign Application Priority Data
Jun. 7, 2021 (CN) 202110630023.0

(51) Int. Cl. B42C 9/00

(52) U.S. Cl. CPC B42C 9/0006

(57) ABSTRACT

A loose-leaf binder includes a front cover; a back cover; a coupler including a first connecting element, a second connecting element, and a covering member interconnecting the first connecting element and the second connecting element; and an enhancement member disposed in the covering member. The front cover is coupled to the first connecting element; and the back cover is coupled to the second connecting element. There are further provided two folding members each disposed between the first connecting element and the covering member or between the second connecting element and the covering member.

### BACKGROUND OF THE INVENTION

### 1. Field of the Invention

The invention relates to loose-leaf binders and more particularly to a loose-leaf binder and a process of producing same.

### 2. Description of Related Art

Conventionally, a loose-leaf binder is adapted to bind a plurality of loose-leaves among a front cover, a back cover and a middle cover coupled to both the front cover and the back cover to form a document which is thus protected. A folding line is formed on an edge of each of the front cover and the back cover so that either the front cover or the back cover can be opened easily. However, the provision of the folding lines increases the manufacturing steps of both the front cover and the back cover. Further, the folding lines may be damaged after a period of time of use. And in turn, it may compromise the covers and damage the document.

Thus, the need for improvement exists.

### SUMMARY OF THE INVENTION

The invention has been made in an effort to solve the problems of the conventional art by providing a loose-leaf binder having novel and nonobvious characteristics.

To achieve above and other objects of the invention, a first aspect of the invention provides a loose-leaf binder comprising a front cover; a back cover; a coupler including a first connecting element, a second connecting element, and a covering member interconnecting the first connecting element and the second connecting element; and an enhancement member disposed in the covering member; wherein the front cover is coupled to the first connecting element; and the back cover is coupled to the second connecting element; further comprising two folding members each disposed between the first connecting element and the covering member or between the second connecting element and the covering member.

Preferably, the coupler further comprises a first positioning member disposed between the first connecting element and the covering member, and a second positioning member disposed between the second connecting element and covering member; and wherein the first positioning member, the second positioning member, and the covering member together are configured to accommodate the enhancement member.

Preferably, further comprises a hot melt adhesive layer adhered to the enhancement member distal the covering member.

Preferably, the enhancement member is shaped as a plate; the first positioning member is perpendicular to the front cover; the second positioning member is perpendicular to the back cover; and the plurality of loose-leaves are bound in a space defined by the first connecting element, the folding members, the first positioning member, the enhancement member, the second positioning member, and the second connecting element.

Preferably, the hot melt adhesive layer includes a main adhesive member and two extension members each extending out of either end of the main adhesive member; the main adhesive member is adhered to the enhancement member; and the extension members are adhered to the first positioning member and the second positioning member respectively.

Preferably, the enhancement member includes a horizontal section and two vertical sections extending from two ends of the horizontal section respectively; the horizontal section and the vertical sections are disposed in the covering member; the first positioning member is disposed on an inner surface of one vertical section and the second positioning member is disposed on an inner surface of the other vertical section respectively; the first positioning member is parallel to the front cover and the second positioning member is parallel to the back cover respectively; and the plurality of loose-leaves are bound in a space defined by the first connecting element, the folding members, the first positioning member, the second positioning member, and the second connecting element.

Preferably, the hot melt adhesive layer is adhered to the horizontal section and two ends of the hot melt adhesive layer are extended to adhere to the vertical sections respectively.

A second aspect of the invention provides a process of producing a loose-leaf binder, comprising the steps of (1) preparing a coupler, a first connecting element and a second connecting element all made of leatherette paper; (2) attaching one surface of an enhancement member to a covering member and attaching a first positioning member at one end of the covering member and a second positioning member at the other end of the covering member to the other surface of the enhancement member; (3) applying a hot melt adhesive layer to the other surface of the enhancement member to adhere a main adhesive member to the enhancement member and adhere two extension members each extending out of an end of the main adhesive member to the first positioning member and the second positioning member respectively; and (4) securing a first plastic layer of the front cover to the first connecting element by means of high frequency welding, securing a second plastic layer of the back cover to the second connecting element by means of high frequency welding, and forming two folding members each disposed between the first connecting element and the first positioning member or between the second connecting element and the second positioning member so that a plurality of loose-leaves is configured to bind in a space defined by the first connecting element, the folding members, the extension members, the main adhesive member and the second connecting element.

A third aspect of the invention provides a process of producing a loose-leaf binder, comprising the steps of (a) preparing a coupler, a first connecting element and a second connecting element all made of leatherette paper; (b) preparing an enhancement member including a horizontal section and two vertical sections extending from two ends of the horizontal section respectively; (c) disposing the horizontal section and the vertical sections in a covering member, disposing the first positioning member on an inner surface of one vertical section, and disposing the second positioning member on the inner surface of the other vertical section; (d) applying a hot melt adhesive layer to one surface of the enhancement member to adhere a bottom of the hot melt adhesive layer to the horizontal section and adhere two ends of the hot melt adhesive layer to the vertical sections respectively; and (e) securing a first plastic layer of a front cover to the first connecting element by means of high frequency welding, securing a second plastic layer of a back cover to the second connecting element by means of high frequency welding, and forming two folding members each disposed between the first connecting element and the first positioning member or between the second connecting element and the second positioning member so that a plurality of loose-leaves are configured to bind in a space defined by the first connecting element, the folding members, the first positioning member, the hot melt adhesive layer, the second positioning member, the second connecting element and the back cover.

The above and other objects, features and advantages of the invention will become apparent from the following detailed description taken with the accompanying drawings.

### BRIEF DESCRIPTION OF THE DRAWINGS

FIG. 1 is a sectional view showing a loose-leaf binder according to a first preferred embodiment of the invention;

FIG. 2 is a sectional view showing loose-leaves to be bound by the loose-leaf binder;

FIG. 3 is a detailed view of the area 3 in FIG. 2;

FIG. 4 is a flow chart of a process of producing a loose-leaf binder according to a first configuration of the invention;

FIG. 5 is a sectional view showing a loose-leaf binder according to a second preferred embodiment of the invention;

FIG. 6 is a sectional view showing loose-leaves to be bound by the loose-leaf binder;

FIG. 7 is a detailed view of the area 7 in FIG. 6; and

FIG. 8 is a flow chart of a process of producing a loose-leaf binder according to a second configuration of the invention.

### DETAILED DESCRIPTION OF THE INVENTION

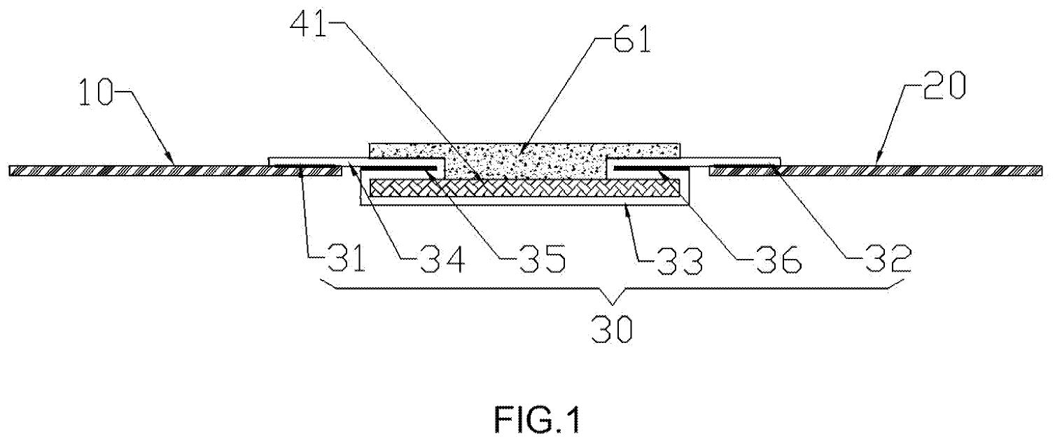

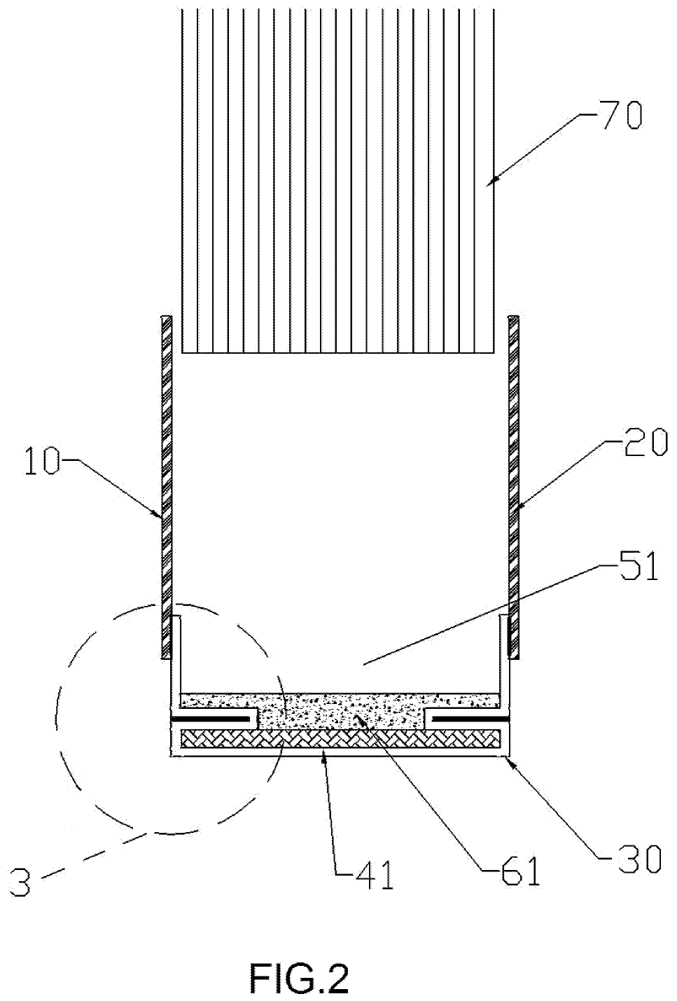

Referring to FIGS. 1 to 3, a loose-leaf binder in accordance with a first preferred embodiment of the invention comprises a front cover 10, a back cover 20, a coupler 30 and an enhancement member 41 as discussed in detail below. The coupler 30 includes a first connecting element 31, a second connecting element 32 and a covering member 33 interconnecting the first connecting element 31 and the second connecting element 32. The enhancement member 41 is disposed in the covering member 33 for increasing stiffness of the middle cover and increase a sufficient space for binding a plurality of loose-leaves 70 between the front cover 10 and back cover 20. The front cover 10 is coupled to the first connecting element 31. The back cover 20 is coupled to the second connecting element 32. Two folding members 34 each are disposed between the first connecting element 31 and the covering member 33 or between the second connecting element 32 and the covering member 33 in which the folding member 34 between the first connecting element 31 and the covering member 33 is relatively flexible with respect to the first connecting element 31, and the folding member 34 between the second connecting element 32 and the covering member 33 is relatively flexible with respect to the first connecting element 31.

It is envisaged by the invention that the front cover 10 can be opened without folding line provided therein. Thus, it is not prone to damage and its useful life is prolonged greatly.

In the embodiment, the coupler 30 further comprises a first positioning member 35 and a second positioning member 36 in which the first positioning member 35 is disposed between the first connecting element 31 and the covering member 33, and the second positioning member 36 is disposed between the second connecting element 32 and covering member 33. A space is formed by the first positioning member 35, the second positioning member 36 and the covering member 33 for accommodating the enhancement member 41. The provision of the first positioning member 35 and the second positioning member 36 and in cooperation with the covering member 33 fastens the enhancement member 41 in the covering member 33.

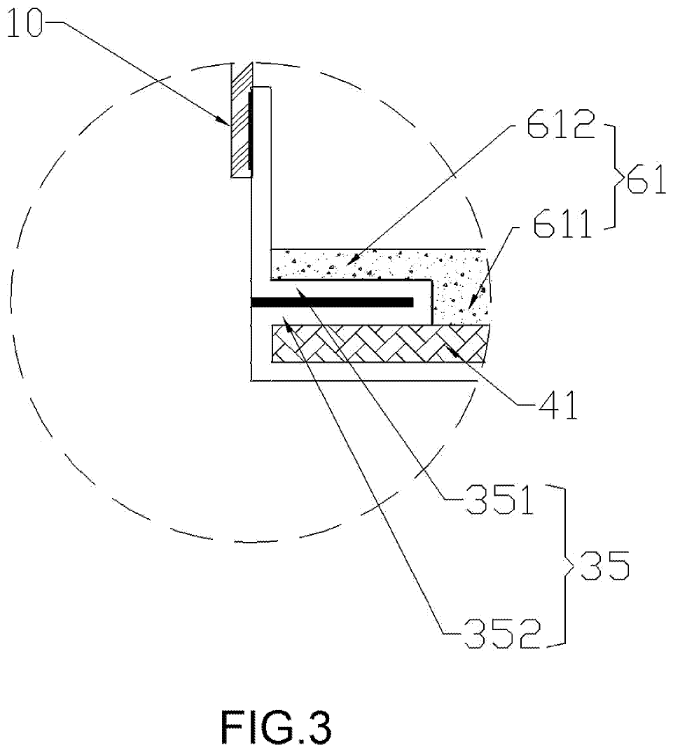

As shown in FIG. 3 specifically, the first positioning member 35 includes a first folding layer 351 and a second folding layer 352 formed with the first folding layer 351. One end of the first folding layer 351 is secured to both the front cover 10 and the first connecting element 31 and the other end thereof is formed with one end of the second folding layer 352. The other end of the second folding layer 352 is formed with the covering member 33. Both the first folding layer 351 and the second folding layer 352 are at one side of the enhancement member 41. The first folding layer 351 and the second folding layer 352 are secured together by means of high frequency welding. The enhancement member 41 is secured by both the first folding layer 351 and the second folding layer 352 and thus has an increased hardness.

In the embodiment, there is further provided a hot melt adhesive layer 61 adhered to the surface of the enhancement member 41 distal the covering member 33. The hot melt adhesive layer 61 is sticky when hot, and solidifies shortly after being applied. The loose-leaves 70 are bound by the solidified hot melt adhesive layer 61.

In the embodiment, both the first connecting element 31 and the second connecting element 32 are made of leatherette paper. A first plastic layer (not shown) is sandwiched between the front cover 10 and the first connecting element 31 and a second plastic layer (not shown) is sandwiched between the back cover 20 and the second connecting element 32. The leatherette paper and plastic layer are fastened by means of high frequency welding. It is noted that the plastic layers formed on the surface of the PVC material correspond to the first and second plastic layers. Alternatively, the front cover 10 or the back cover 20 or both are made of cardboard so that plastic oil can be applied on a joining position of the front cover 10 and the first connecting element 31, and plastic oil can be applied on a joining position of the back cover 20 and the second connecting element 32 respectively. This can effect a subsequent high frequency welding. In the invention, the front cover 10 is secured to the coupler 30 by means of high frequency welding and the back cover 20 is secured to the coupler 30 by means of high frequency welding and the back cover 20 respectively. This makes operation easy, decreases manufacturing cost and saves manufacturing time.

Preferably, the first connecting element 31, the second connecting element 32, the folding members 34, the first positioning member 35, the second positioning member 36, and the covering member 33 of the coupler 30 are made of leatherette paper and formed integrally. Thus, the folding members 34 have sufficient flexibility and malleability to be foldable and are not prone to damage.

In the embodiment, the enhancement member 41 is a plate shaped member. The first positioning member 35 is perpendicular to the front cover 10. The second positioning member 36 is perpendicular to the back cover 20. The loose-leaves 70 are bound in a space 51 defined by the first connecting element 31, the folding members 34, the first positioning member 35, the enhancement member 41, the second positioning member 36, and the second connecting element 32. The enhancement member 41 is implemented as a spinal enhanced layer. Both the front cover 10 and the back cover 20 can be folded about 180-degree to facilitate an opening of the document formed by the binder.

Further, the hot melt adhesive layer 61 includes a main adhesive member 611 and an extension member 612 extending out of either end of the main adhesive member 611. The main adhesive member 611 is adhered to the enhancement member 41. The extension members 612 are adhered to the first positioning member 35 and the second positioning member 36 respectively. The hot melt adhesive layer 61 is disposed at a bottom of the space 51 so that both the first connecting element 31 and the second connecting element 32 can contact the extension member 612, thereby ensuring a fastening of the bound document.

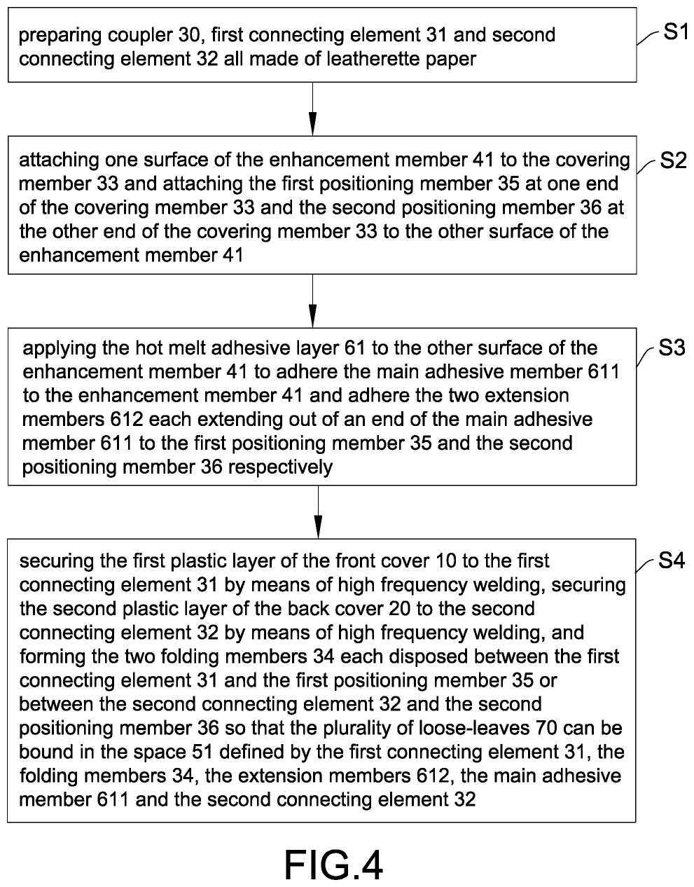

Referring FIG. 4, a flow chart of a process of producing a loose-leaf binder according to a first configuration of the invention is illustrated. In conjunction with FIGS. 1 to 3, the process comprises the following steps of:

S1 preparing the coupler 30, the first connecting element 31 and the second connecting element 32 all made of leatherette paper;

S2 attaching one surface of the enhancement member 41 to the covering member 33 and attaching the first positioning member 35 at one end of the covering member 33 and the second positioning member 36 at the other end of the covering member 33 to the other surface of the enhancement member 41;

S3 applying the hot melt adhesive layer 61 to the other surface of the enhancement member 41 to adhere the main adhesive member 611 to the enhancement member 41 and adhere the two extension members 612 each extending out of an end of the main adhesive member 611 to the first positioning member 35 and the second positioning member 36 respectively; and

S4 securing the first plastic layer of the front cover 10 to the first connecting element 31 by means of high frequency welding, securing the second plastic layer of the back cover 20 to the second connecting element 32 by means of high frequency welding, and forming the two folding members 34 each disposed between the first connecting element 31 and the first positioning member 35 or between the second connecting element 32 and the second positioning member 36 so that the plurality of loose-leaves 70 can be bound in the space 51 defined by the first connecting element 31, the folding members 34, the extension members 612, the main adhesive member 611 and the second connecting element 32.

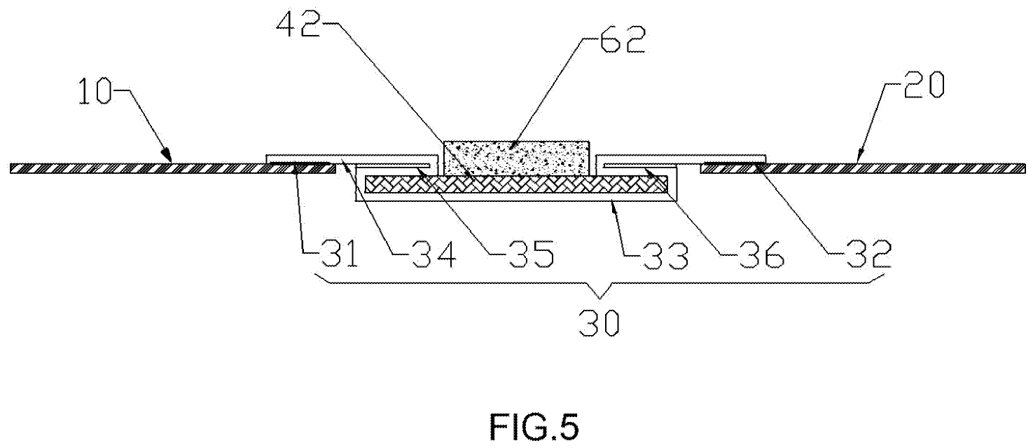

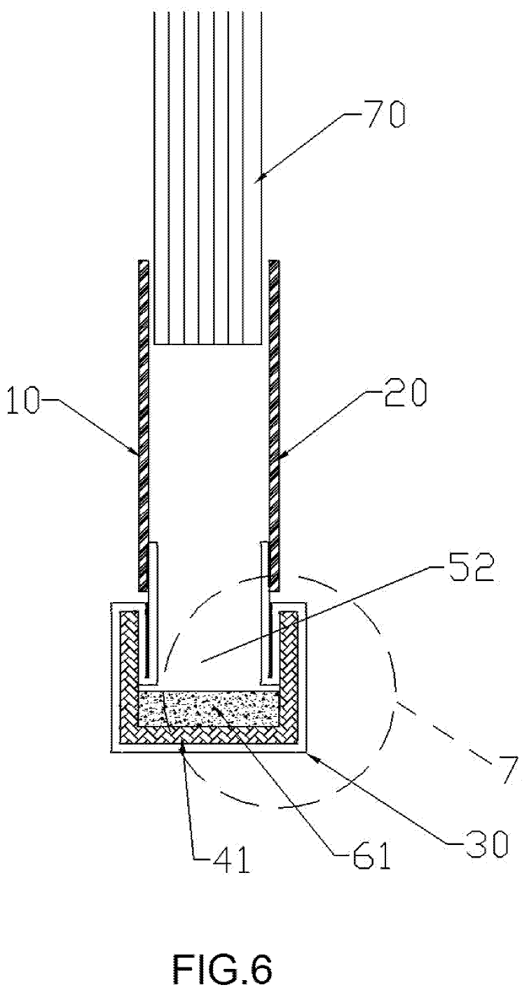

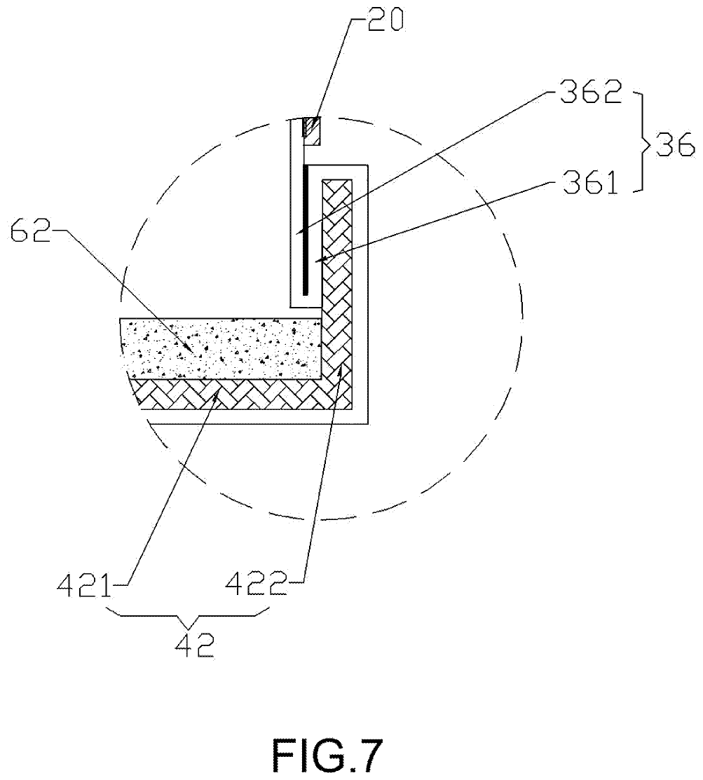

Referring to FIGS. 5 to 7, a loose-leaf binder in accordance with a second preferred embodiment of the invention is shown. The characteristics of the second preferred embodiment are substantially the same as that of the first preferred embodiment except the following: the enhancement member 42 includes a horizontal section 421 and two vertical sections 422 extending from two ends of the horizontal section 421 respectively. The horizontal section 421 and the vertical sections 422 are disposed in the covering member 33. The first positioning member 35 is disposed on an inner surface of one vertical section 422 and the second positioning member 36 is disposed on an inner surface of the other vertical section 422. The first positioning member 35 is parallel to the front cover 10 and the second positioning member 36 is parallel to the back cover 20 respectively. The loose-leaves 70 are bound in a space 52 defined by the first connecting element 31, the folding members 34, the first positioning member 35, the second positioning member 36, and the second connecting element 32. The horizontal section 421 and the vertical sections 422 form a U-shaped space for accommodating the bound loose-leaves 70.

In the embodiment, the hot melt adhesive layer 62 is applied to a bottom of the U-shaped space only. The hot melt adhesive layer 62 is adhered to the horizontal section 421 and two ends of the hot melt adhesive layer 62 are extended to adhere to the vertical sections 422 respectively.

It is noted that the enhancement member 42 is made of metal for increasing hardness. Alternatively, the enhancement member 42 is made of thermosetting polymer or cardboard so that the spinal structure of the enhancement member 42 has a sufficient hardness and is shaped to accommodating the bound loose-leaves 70. The material of the enhancement member 42 can be chosen based on requirements.

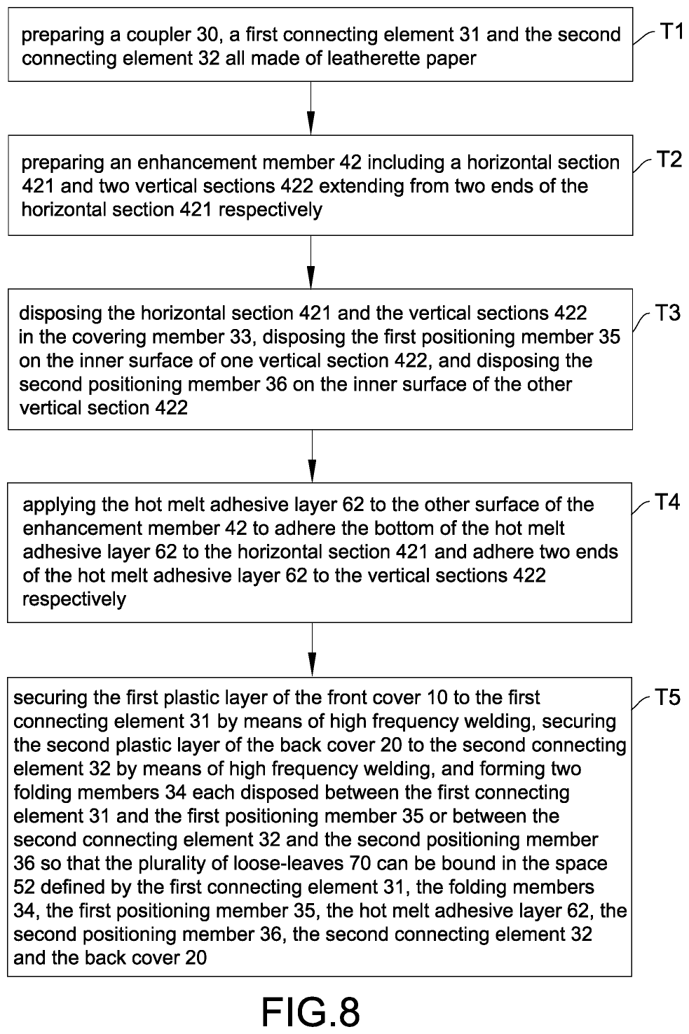

Referring FIG. 8, a flow chart of a process of producing a loose-leaf binder according to a second configuration of the invention is illustrated. In conjunction with FIGS. 5 to 7, the process comprises the following steps of:

T1 preparing a coupler 30, a first connecting element 31 and the second connecting element 32 all made of leatherette paper;

T2 preparing an enhancement member 42 including a horizontal section 421 and two vertical sections 422 extending from two ends of the horizontal section 421 respectively;

T3 disposing the horizontal section 421 and the vertical sections 422 in the covering member 33, disposing the first positioning member 35 on the inner surface of one vertical section 422, and disposing the second positioning member 36 on the inner surface of the other vertical section 422;

T4 applying the hot melt adhesive layer 62 to the other surface of the enhancement member 42 to adhere the bottom of the hot melt adhesive layer 62 to the horizontal section 421 and adhere two ends of the hot melt adhesive layer 62 to the vertical sections 422 respectively; and

T5 securing the first plastic layer of the front cover 10 to the first connecting element 31 by means of high frequency welding, securing the second plastic layer of the back cover 20 to the second connecting element 32 by means of high frequency welding, and forming two folding members 34 each disposed between the first connecting element 31 and the first positioning member 35 or between the second connecting element 32 and the second positioning member 36 so that the plurality of loose-leaves 70 can be bound in the space 52 defined by the first connecting element 31, the folding members 34, the first positioning member 35, the hot melt adhesive layer 62, the second positioning member 36, the second connecting element 32 and the back cover 20.

While the invention has been described in terms of preferred embodiments, those skilled in the art will recognize that the invention can be practiced with modifications within the spirit and scope of the appended claims.

What is claimed is:

1. A loose-leaf binder for binding a plurality of loose-leaves, comprising:
a front cover;
a back cover;
a coupler including a first connecting element, a second connecting element, and a covering member interconnecting the first connecting element and the second connecting element; and
an enhancement member disposed in the covering member;
wherein the front cover is coupled to the first connecting element; and the back cover is coupled to the second connecting element;
further comprising two folding members each disposed between the first connecting element and the covering member or between the second connecting element and the covering member.

2. The loose-leaf binder of claim 1, wherein the coupler further comprises a first positioning member disposed between the first connecting element and the covering member, and a second positioning member disposed between the second connecting element and covering member; and wherein the first positioning member, the second positioning member, and the covering member together are configured to accommodate the enhancement member.

3. The loose-leaf binder of claim 2, further comprising a hot melt adhesive layer adhered to the enhancement member distal the covering member.

4. The loose-leaf binder of claim 3, wherein the enhancement member is shaped as a plate; the first positioning member is perpendicular to the front cover; the second positioning member is perpendicular to the back cover; and the plurality of loose-leaves are bound in a space defined by the first connecting element, the folding members, the first positioning member, the enhancement member, the second positioning member, and the second connecting element.

5. The loose-leaf binder of claim 4, wherein the hot melt adhesive layer includes a main adhesive member and two extension members each extending out of either end of the main adhesive member; the main adhesive member is adhered to the enhancement member; and the extension members are adhered to the first positioning member and the second positioning member respectively.

6. The loose-leaf binder of claim 1, wherein the enhancement member includes a horizontal section and two vertical sections extending from two ends of the horizontal section respectively; the horizontal section and the vertical sections are disposed in the covering member; the first positioning member is disposed on an inner surface of one vertical section and the second positioning member is disposed on an inner surface of the other vertical section respectively; the first positioning member is parallel to the front cover and the second positioning member is parallel to the back cover respectively; and the plurality of loose-leaves are bound in a space defined by the first connecting element, the folding members, the first positioning member, the second positioning member, and the second connecting element.

7. The loose-leaf binder of claim 6, wherein the hot melt adhesive layer is adhered to the horizontal section and two ends of the hot melt adhesive layer are extended to adhere to the vertical sections respectively.

8. The loose-leaf binder of claim 2, wherein the coupler is made of leatherette paper; wherein the front cover is secured to the coupler by means of high frequency welding; and wherein the back cover is secured to the coupler by means of high frequency welding and the back cover.

9. A process of producing a loose-leaf binder, comprising the steps of:
(1) preparing a coupler, a first connecting element and a second connecting element all made of leatherette paper;
(2) attaching one surface of an enhancement member to a covering member and attaching a first positioning member at one end of the covering member and a second positioning member at the other end of the covering member to the other surface of the enhancement member;
(3) applying a hot melt adhesive layer to the other surface of the enhancement member to adhere a main adhesive member to the enhancement member and adhere two extension members each extending out of an end of the main adhesive member to the first positioning member and the second positioning member respectively; and
(4) securing a first plastic layer of the front cover to the first connecting element by means of high frequency welding, securing a second plastic layer of the back cover to the second connecting element by means of high frequency welding, and forming two folding members each disposed between the first connecting element and the first positioning member or between the second connecting element and the second positioning member so that a plurality of loose-leaves is configured to bind in a space defined by the first connecting element, the folding members, the extension members, the main adhesive member and the second connecting element.

10. A process of producing a loose-leaf binder, comprising the steps of:
(a) preparing a coupler, a first connecting element and a second connecting element all made of leatherette paper;
(b) preparing an enhancement member including a horizontal section and two vertical sections extending from two ends of the horizontal section respectively;
(c) disposing the horizontal section and the vertical sections in a covering member, disposing the first positioning member on an inner surface of one vertical section, and disposing the second positioning member on the inner surface of the other vertical section;
(d) applying a hot melt adhesive layer to one surface of the enhancement member to adhere a bottom of the hot melt adhesive layer to the horizontal section and adhere two ends of the hot melt adhesive layer to the vertical sections respectively; and
(e) securing a first plastic layer of a front cover to the first connecting element by means of high frequency welding, securing a second plastic layer of a back cover to the second connecting element by means of high frequency welding, and forming two folding members each disposed between the first connecting element and the first positioning member or between the second connecting element and the second positioning member so that a plurality of loose-leaves are configured to bind in a space defined by the first connecting element, the folding members, the first positioning member, the hot melt adhesive layer, the second positioning member, the second connecting element and the back cover.
